(19) United States
(12) Patent Application Publication
(10) Pub. No.: US 2012/0011013 A1
(43) Pub. Date: Jan. 12, 2012

(54) CASH AND CREDIT PRICING OF DIGITAL MEDIA USING CREDIT PACKS

(75) Inventors: Mark Vanderland, Calgary (CA); Anne Maura Dawson, Calgary (CA); Mark Retzer, Calgary (CA); Phong Tu, Calgary (CA); Viet Q. Hoang, Calgary (CA)

(73) Assignee: CORBIS, INC., Seattle, WA (US)

(21) Appl. No.: 12/832,541

(22) Filed: Jul. 8, 2010

(51) Int. Cl. G06Q 30/00

(52) U.S. Cl. 705/26.1

(57) ABSTRACT

Embodiments are directed towards providing a method and a system for licensing digital media items, including providing a search interface for a web browser, which enables a customer to interactively select one or more media items from a plurality of media items available for licensing, establishing prices in credits for licenses to the plurality of media items, determining cash prices corresponding to the prices in credits for the licenses to the plurality of media items, enabling a customer to purchase one or more credit packs, each credit pack including a specified number of credits for a specified price; and, enabling the customer to pay for the licenses to the one or more selected media items with cash, or with credits from the one or more credit packs purchased by the customer.

### TECHNICAL FIELD

Various embodiments generally relate to the licensing and pricing of digital media, and more particularly, but not exclusively, to a system that unifies the pricing and licensing of digital media managed by a digital media system using cash or credits.

### BACKGROUND

Online digital media systems enable customers to search for, select, price and license digital media items to be downloaded for subsequent use. Uses for digital media include advertising, incorporation into print publications such as newspapers and magazines, incorporation into online publications such as websites and blogs and personal consumption, such as listening to music at home.

Electronic commerce, or e-commerce, systems enable customers to browse items for sale and add them to an electronic cart, or simply “cart”, and then purchase the items. Typically the items are goods or services that have fixed prices. For example, the online e-commerce website of Amazon.com of Seattle, Wash., an e-commerce pioneer, enables a customer to select a book, CD or DVD and add it to a cart. The customer may check out the selection or may continue shopping. E-commerce systems are also used to sell or license digital media items such as digital images, digital video, digital music and the like. Some e-commerce systems also include a “buy now” feature that enables a customer to purchase a product directly from a product detail page without first adding it to a cart.

One licensing model that online digital media systems, DMSs, commonly offer is the “royalty free”, or RF, license model, in which digital media is licensed for an unlimited time period and for a broad set of uses. Under the RF licensing model a digital media item is typically licensed for a fixed price. In the case of digital images, specific sizes or resolutions of a digital image may have different prices. This pricing model also applies to licensing of “microstock” which refers to very low priced digital media.

Further, when selling large numbers of digital media items, DMSs, such as stock photography systems, often employ pricing tiers. For example, a three tier system may be employed that places high quality or rare media items in a “premium” tier, medium value items in a “mid” tier and lower value items in a “value” tier. Each tier may have distinct usage rights associated with it.

When purchasing licenses to digital media, two distinct methods of payment are used: cash and credits. In the case of cash payment, the customer pays for licenses using a credit card, a debit account, an electronic payment system such as PAYPAL®, operated by eBay of San Jose, Calif., or other cash equivalent method of payment. Credits are typically offered in a “credit pack” that consists of a fixed number of credits purchased using a cash payment method. After a customer purchases credits in a credit pack, he/she may use them flexibly to pay for licenses to media items. Unused credits remain in the customer's account, available for later use, either for an unlimited period of time or for a specified maximum time period. Typically, there are a variety of credit packs, for example a 10 unit credit pack, 20 unit credit pack and so forth. Credit-based payment systems are a form of loyalty program since unused credits purchased from a DMS provide an incentive to the customer to return to the DMS and make additional purchases. Therefore, purchases using credit are often discounted relative to cash purchases. For a variety of reasons, some customers prefer to pay with cash, while other customers prefer to pay with credits. However, prior art DMS do not enable a customer to flexibly pay for licenses using either cash or credits. Typically, a DMS offers only one method of payment, cash or credits, but not both. Therefore, it would be desirable for a DMS to enable the customer to flexibly pay using either or both of cash or credits.

### SUMMARY OF THE DESCRIPTION

Various embodiments are directed towards payment for licenses to digital media using cash or credits, where credits are purchased as part of license packs. Provided in one embodiment is a search interface that enables a customer to filter media items stored in a digital media library using a desired size and desired price range and to view the license prices for digital media selected by the filter in either credits or cash.

Another embodiment is directed toward a purchase interface that enables a customer to pay for a license to a digital media item using either cash or credits.

Yet another embodiment is directed toward an electronic cart that enables a customer to pay for a license to one or more digital media items using either cash or credits.

In another embodiment of the subject invention a method for calculating a credits to cash conversion table is used to determine a cash price that corresponds to a previously established price in credits. In one embodiment, the method for calculating a corresponding cash price for a specified credit value is based in part on the lowest price for purchasing credit packs that cumulatively contain at least the specified credit value.

In one embodiment of the subject invention, a method for licensing digital media items includes providing a search interface for a web browser, which enables a customer to interactively select one or more media items from a plurality of media items available for licensing, establishing prices in credits for licenses to the plurality of media items, determining cash prices corresponding to the prices in credits for the licenses to the plurality of media items, enabling a customer to purchase one or more credit packs, each credit pack including a specified number of credits for a specified price; and enabling the customer to pay for the licenses to the one or more selected media items with cash, or with credits from the one or more credit packs purchased by the customer.

In a further embodiment of the subject invention, a system for licensing digital media items includes a pricer for establishing prices in credits for licenses to a plurality of media items available for licensing, and determining cash prices corresponding to the prices in credits for the licenses to the plurality of media items, and an application server for providing a search interface for a web browser, which enables a customer to interactively select one or more media items from the plurality of media items available for licensing, and providing a purchase interface for a web browser, which enables a customer to purchase one or more credit packs, each credit pack including a specified number of credits for a specified price, and enables the customer to pay for the licenses to the one or more selected media items with cash, or with credits from the one or more credit packs purchased by the customer.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Preferred Embodiment, which is to be read in association with the accompanying drawings, wherein:

FIG. 1 is a system diagram of one environment in which the invention may be practiced;

FIG. 2 is a block diagram for an online digital media system;

FIG. 3 is an illustration of one embodiment of a user interface of a search interface for searching for digital images from a digital media library;

FIG. 4 is an illustration of one embodiment of a user interface for purchasing a license to a media item using cash or credits;

FIG. 5 is an illustration of one embodiment of a user interface for an electronic cart that enables a customer to license one or more media items using cash or credits;

FIGS. 6A and 6B are flow diagrams of a method that enables a customer to interactively search for, select and purchase licenses to one or more media items using cash or credits;

FIG. 7A illustrates a method for establishing a license price for a media item using credits purchased as part of a credit pack;

FIG. 7B illustrates a method for determining a corresponding cash price for licensing a media item when the price was initially established in credits; and

FIG. 8 provides an exemplary credits to cash conversion table used in converting credit prices to cash prices for licenses to media items.

### DETAILED DESCRIPTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, business methods or devices. Accordingly, the present invention may take the form of an entirely hardware embodiment, an entirely software embodiment or an embodiment combining software and hardware aspects. The following detailed description is, therefore, not to be taken in a limiting sense.

As used herein the following terms have the meanings given below:

Digital media item, digital media, or media item—means a file or unit of information stored in digital format that can be referred to, displayed or played. Digital media includes digital photographs, commonly referred to as “digital images” or simply “images”, digital videos, vector art, Flash animations, sound files, and the like. For embodiments discussed herein, digital media may comprise content that was originally created digitally, or content that was converted from analog to digital format.

User or customer—means an individual that uses a mobile device, PC or other electronic device capable of accessing a website or other service available across a network, to search for and license digital media offered by an online digital media licensing system.

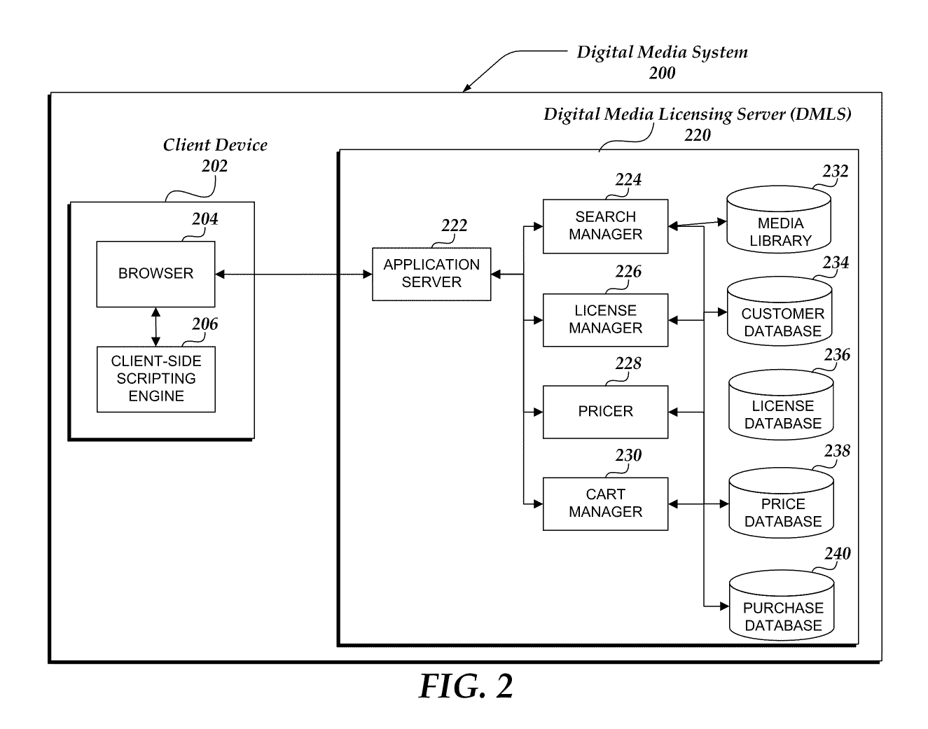

Digital media library—means a collection of digital media items that are accessed using a client computer. The digital media licensing system described herein with reference to FIG. 2 provides such a digital media library. Some embodiments of a digital media library are also referred to as a “stock media” library or “stock photo” library.

Check out—means the process of paying for one or more licenses to digital media items in an electronic cart. In this regard, the term “checkout” also refers to an interactive user interface used for checking out. Additional functions may be performed while checking out, including, but not limited, to specifying a method of payment, specifying download options, specifying delivery options, changing a method of payment, deleting items, specifying a payee, providing contact information, and selecting delivery media options, including, inter alia, prints, transparencies, copies on media such as CD ROM and DVD ROM.

Credit—means a unit of currency managed by and purchased from a digital media system, or other e-commerce website or system, that is used to purchase or license digital media items or other merchandise, from the system.

Credit pack—a specified number of credits that may be purchased for a specified price. Typically, different size credit packs are offered for purchase, each containing a different number of credits at a different price.

Embodiments of the present invention enable customers of an online digital media system (DMS) to specify criteria for a search, to search through a digital media library, to select digital media items, to add selected digital media items to an electronic cart for purposes of licensing and to pay for licenses to the selected digital media items using cash or credits, where credits are purchased in credit packs of different sizes and prices. Some of the examples provided herein are constrained to digital media libraries that include only digital images or only digital images and digital video clips. However, the methods, processes, and systems described herein can be applied to digital media libraries that include any type of digital media or content, including, inter alia, images, music and sound, video, movies, graphics, web pages, and text documents.

Embodiments of the present invention concern a method for determining a cash price that corresponds to a credit value where credits are purchased in a license pack. The same method, with little modification can equally be applied to determine a number of credits that corresponds to a cash price.

Embodiments further provide a customer with user interfaces for searching for, filtering, selecting and purchasing licenses to digital media items from a digital media library.

### Illustrative Operating Environment

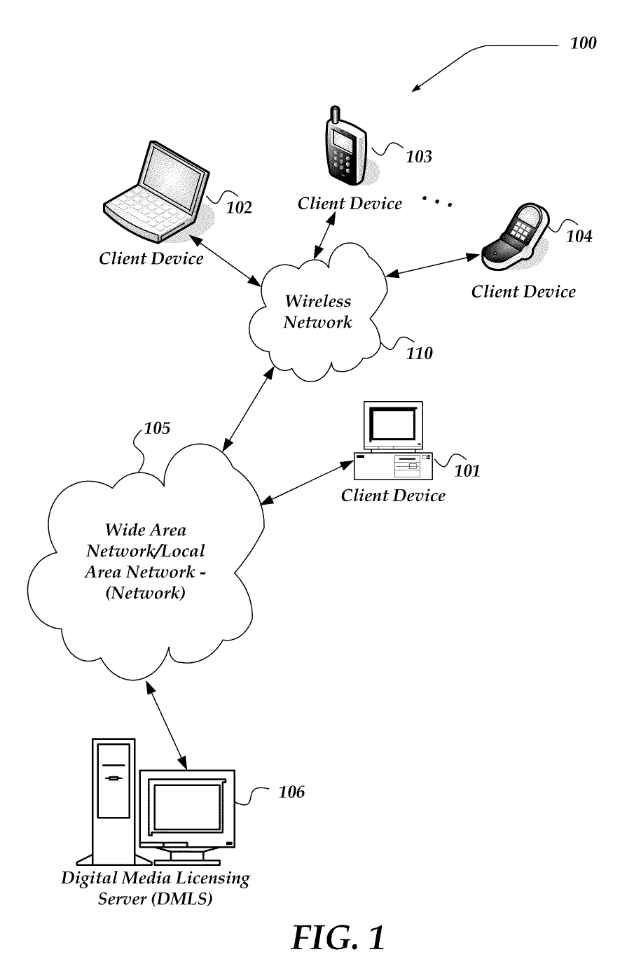

FIG. 1 shows components of one environment in which the invention may be practiced. Not all of the components may be required to practice the invention, and variations in the arrangement and types of the components may be made without departing from the spirit or scope of the invention. As shown, system 100 of FIG. 1 includes wide area network (“WAN”)/local area network (“LAN”)—(network) 105, wireless network 110, client devices 101-104, and a digital media licensing server (DMLS) 106.

Generally, client devices 101-104 include any computing devices that are capable of receiving and sending messages over a network, such as network 105, wireless network 110, or the like, such as personal computers, multiprocessor systems, microprocessor-based or programmable consumer electronics, network PCs, or the like. Client devices 101-104 also include portable devices such as mobile telephones, smart phones, display pagers, radio frequency (RF) devices, infrared (IR) devices, personal digital assistants (PDAs), handheld computers, laptop computers, wearable computers, tablet computers, integrated devices combining one or more of the preceding devices, or the like.

Client devices 101-104 typically range widely in terms of capabilities and features. For example, a cell phone may have a numeric keypad and a few lines of monochrome LCD display on which only text may be displayed. In another example, a web-enabled client device may have a touch sensitive screen, a stylus and several lines of color LCD display in which both text and graphics may be displayed.

### Client Applications

Client devices 101-104 may include client application programs that send and receive content to/from other computing devices. Examples of application programs include calendars, browsers, email clients, IM applications, SMS applications, VoIP applications, contact managers, task managers, transcoders, database programs, word processing programs, security applications, spreadsheet programs, games, search programs, and so forth.

Client devices 101-104 may be configured to include an application program that enables a customer to log into a customer account that may be managed by another computing device, such as DMLS 106, or the like. Such customer account, for example, may be configured to enable the customer to send/receive email messages, send/receive IM messages, send/receive SMS messages, access selected web pages, search, browse, view and license digital media, or participate in any of a variety of other networking activity.

A web-enabled client device may include a browser application that is configured to receive and to send web pages, web-based messages, or the like. The browser application may receive and display graphics, text, multimedia, or the like, employing a web-based language, including a wireless application protocol messages (WAP), or the like. In one embodiment, the browser application is enabled to employ Handheld Device Markup Language (HDML), Wireless Markup Language (WML), WMLScript, JAVASCRIPT, Standard Generalized Markup Language (SMGL), HyperText Markup Language (HTML), eXtensible Markup Language (XML), or the like, to display and send information.

Wireless network 110 is configured to couple client devices 102-104 with network 105. Wireless network 110 may include any of a variety of wireless networks that provide a connection for client devices 102-104. Such networks may include mesh networks, wireless LAN (WLAN) networks, cellular networks, or the like. Wireless network 110 may further include network devices such as gateways routers, or the like. In essence, wireless network 110 may include virtually any wireless communication mechanism by which information may travel between client devices 102-104 and another computing device, network, or the like.

Network 105 is configured to couple DMLS 106, and client device 101 with other computing devices, including through wireless network 110 to client devices 102-104. Network 105 can include the Internet in addition to local area networks (LANs), wide area networks (WANs), direct connections, such as through a universal serial bus (USB) port, or any combination thereof. In essence, network 105 includes any communication method by which information may travel between computing devices.

DMLS 106 represents a network computing device that is configured to enable a customer to search a digital media library, or database, select digital media items, add the selected items to an electronic cart, and purchase the selected items or licenses to the selected items. Devices that may operate as DMLS 106 include, but are not limited to personal computers, desktop computers, multiprocessor systems, microprocessor-based or programmable consumer electronics, network PCs, servers, network appliances, and the like.

Although DMLS 106 is illustrated as a distinct network device, the invention is not so limited. For example, a plurality of network devices may be configured to perform the functions of DMLS 106.

DMLS 106 is capable of running application programs (“applications”). Applications that may be run by DMLS 106 include transcoders, schedulers, calendars, database programs, word processing programs, HTTP programs and processes, customizable user interface programs, security applications, encryption programs, VPN programs, web servers, account management, and so forth. Applications run by DMLS 106 may also include a search manager, license manager, pricer, a cart manager, and a database manager such as those described in more detail below in conjunction with FIG. 2.

DMLS 106 typically provides web services which include any of a variety of network services that are configured to provide content, including messages, over a network to another computing device. Thus, web services include for example, an application server, a web server, a messaging server, a File Transfer Protocol (FTP) server, a database server, a content server, or the like. Web services may provide the content including messages over the network using any of a variety of formats, including, but not limited to WAP, HDML, WML, SMGL, HTML, XML, cHTML, xHTML, or the like. Web services may also include server-side scripting languages such as PHP, Python, and Java servlets. Web services may also include the server side of the Ajax web development method that enables a server to asynchronously respond to Ajax requests. The server-side Ajax component can be implemented using any server-side technology that can dynamically deliver information in XML or JSON format.

DMLS 106 includes data storage for storing program code and data. Data storage may include virtually any mechanism usable for storing and managing data, including but not limited to a file, a folder, a document, a web page or an application, such as a database, a spreadsheet, digital media including digital images and digital video clips, and the like.

Data storage may further represent a plurality of different data stores. For example, data storage may represent a media library, a customer database, a license database, a price database, and/or a purchase database, such as those described in more detail below in conjunction with FIG. 2. Further, data storage may also include network storage or cloud storage in which the physical storage media is accessed across a network.

### Generalized Operation

The operation of certain aspects of the invention is described below with respect to FIGS. 2-8.

Reference is now made to FIG. 2, which is one embodiment of a block diagram for an online digital media system 200. Digital media system 200 enables one or more client devices 202 to access a library of digital media managed by a digital media licensing server (DMLS) 220, which is an embodiment of digital media licensing server 106, across a network, such as wide area/local area network 105. In one embodiment, source content from one or more different sources is ingested, processed, and made available by DMLS 220 for searching, browsing, and licensing by customers. Client device 202 represents one embodiment of client devices 101-104 of FIG. 1. Typically a customer uses browser 204, running on client device 202 to access DMLS 220. The user interface provided by browser 204 enables a customer to perform a range of functions related to licensing digital media including browsing, searching and viewing media items, viewing and selecting license terms, obtaining pricing for media items, adding media items to an electronic cart, licensing and paying for media items and downloading media items across the network onto client device 202.

Browser 204 may be a standard, commercially available, browser such as Mozilla Firefox or Microsoft Internet Explorer. Or it may also be a client application configured to receive and display graphics, text, multimedia, and the like, across a network.

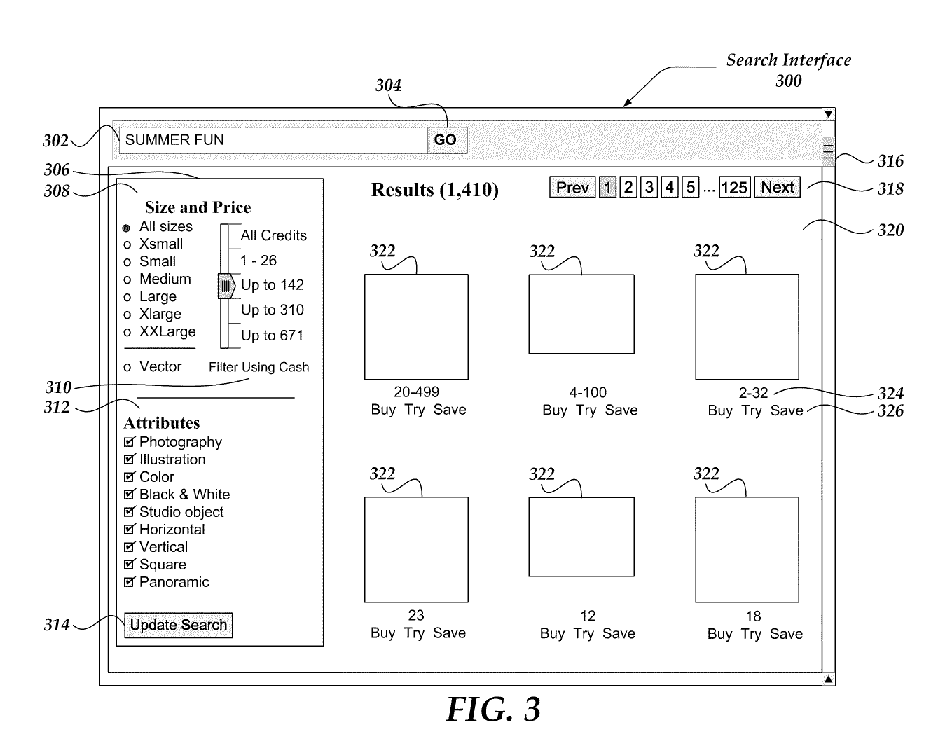

In one embodiment, browser 204 interacts with a client-side scripting engine 206 that executes client-side scripting instructions written in a client-side scripting or programming language such as JAVASCRIPT® from Sun Microsystems, the Java open source programming language, ACTIVEX® from the Microsoft Corporation, and the like. In one embodiment, browser 204 is configured to use the Ajax (asynchronous JavaScript and XML or JSON) web development techniques that are used to create interactive web applications. Rather than referring to a specific standard or product, the term Ajax has come to represent a broad group of web technologies that can be used to implement a Web application that communicates with a server in the background, without interfering with the current state of a web page. When web pages need to be updated, Ajax enables browsers to asynchronously request incremental pieces of information from the server instead of whole pages. Ajax typically works with XML or JavaScript Object Notation (JSON) and a client-side scripting language such as JavaScript or ActiveX. In one embodiment, when a customer accesses DMLS 220 using client device 202, DMLS 220 downloads web pages in HTML format to browser 204 for viewing and interactive use. To perform some of the advanced client-side interactive functions, described with respect to FIGS. 3-5, the web pages may include client-side scripting instructions. Typically, such client-side scripting instructions are embedded in HTML web pages and are interpreted or executed by client-side scripting engine 206 to perform functions not available through HTML commands such as advanced graphics, database access, and computations.

In one embodiment, JavaScript is used as a client-side scripting language. JavaScript is supported by most commercial browsers including Mozilla Firefox, Microsoft Internet Explorer, and Apple Safari. For purposes of specificity, all of the client-side capabilities described herein can be accomplished using browser 204 in conjunction with JavaScript version 1.5, or greater. A description of JavaScript version 1.5 may be found in the book JavaScript: The Definitive Guide, by David Flanagan, August 2006, published by O'Reilly Media, Inc., which is incorporated herein by reference. In one embodiment, JavaScript commands are embedded inside HTML files and are processed by a JavaScript engine which is an embodiment of client-side scripting engine 206.

Browser 204 issues requests using the hypertext transfer protocol (HTTP) to an application server 222. Application server 222 receives the HTTP requests and invokes the appropriate digital media licensing server software module to process the request. Application server 222 may be a commercially available application server that includes a web server that accepts and processes HTTP requests from browser 204 and serves or transmits HTTP responses back to browser 204 along with optional data contents, which usually are web pages such as HTML documents and linked objects (images, or the like). In addition, browser 204 may use Ajax to issue requests for XML or JSON-coded information that is delivered asynchronously by application server 222. Henceforth, the term request message will refer to a message sent by browser 204 using HTTP, Ajax or other client-server communications method to application server 222. And a response message will refer to a message sent in response, typically using the same communications method, by application server 222 to browser 204.

In one embodiment, application server 222 establishes and manages customer sessions. Typically application server 222 assigns each customer session a unique session id. A customer session lasts from the time a customer logs in, or access DMLS 220 from browser 204 until the time the customer logs out or stops interacting with DMLS 220 for a specified period of time. In addition, application server 222 manages server applications and provides database connectivity.

DMLS 220 also includes a search manager 224, a license manager 226, a pricer 228, and a cart manager 230. DMLS 220 further includes five databases: a media library 232, a customer database 234, a license database 236, a price database 238 and a purchase database 240. It may be appreciated that each of the abovementioned databases may be implemented as one or more computer files spread across one or more physical storage mechanisms. In one embodiment, each of the abovementioned databases is implemented as one or more relational databases and is accessed using the structured query language (SQL).

In order to access and search for data and objects residing in media library 232, customer database 234, license database 236, price database 238, and purchase database 240, each of search manager 224, license manager 226, pricer 228, and cart manager 230 may include a commercial relational database management system (RDBMS) such as ORACLE from the Oracle Corporation, SQL Server from the Microsoft Corporation, or the like. However, virtually any other database manager may also be used. In another embodiment, a single RDBMS is shared by one or more of search manager 224, license manager 226, pricer 228 and cart manager 230. In addition to a RDBMS, a standard data extraction tool may be included that simplifies access to relational databases, enabling a developer to express queries visually or in a simplified manner, rather than using structured query language (SQL).

Search manager 224 responds to search requests made by client device 202 by searching media library 232 for media items that match the criteria included in the search requests. In one embodiment, a search request is formatted as an HTML form and search manager 224 transforms the HTML formatted search requests into SQL queries and uses the RDBMS to search for media items that satisfy the query. In another embodiment, search manager 224 formats selected data from media library 232 in memory in structures that are highly optimized for search and information retrieval and does not directly query media library 232 when performing search requests.

Media library 232 stores digital media items and metadata for each media item. Typically, digital media items and metadata are stored and retrieved using a database management system. In one embodiment, each media item is described by a database record that includes fields such as those listed and described in Table 1 below:

TABLE 1
Media Library Database Fields For A Media Item

| Name Of Field | Description |
|---|---|
| Unique ID | Unique identifier for the media item. Used as |
| | key to access database information about the |
| | media item. |
| Title | Title of media item. The title is typically |
| | displayed to the customer. |
| Price tier | Price tier associated with the media item, such |
| | as Premium, Mid, or Value. |
| Attributes | A list of attributes possessed by the media |
| | item, such as media type (photography, |
| | illustration, vector illustration, etc.), color |
| | model (color, black and white, etc.), aspect |
| | ratio (vertical, square, panoramic), size and |
| | resolution. |
| Keywords | List of keywords used for searching. |

In another embodiment, the fields listed in Table 1 are stored as a relational table using a relational database management system where the Unique ID field serves as the key. In one embodiment, digital media items such as digital images and digital video clips are stored outside the relational database(s) that implement media library 232, e.g. in the local file system, or in remotely accessible network storage, and a unique identifier which references the media item is stored inside the database. In another embodiment, digital media items such as digital images and digital video clips are stored as binary large objects (BLOBS) within the relational database.

Customer database 234 stores information about each registered customer. Customer database 234 stores inter alia name, contact information and means of payment information. Name and contact information is typically obtained during registration. Typically, a customer registers with DMS 200 prior to completing a purchase. Method of payment information is typically obtained at the time of purchase. If a customer has previously purchased a credit pack, customer database 234 stores information about any unused credits.

License manager 226 responds to requests for license information for one or more media assets by querying a license database 236 for license information regarding the media items referenced in the request. Such requests for license information include, inter alia, license options that apply to a price tier, terms of availability and any special pricing. License manager 226 responds to requests to validate the availability for licensing of a media item during checkout. To accomplish this, license manager 226 reviews information regarding licenses to the media item currently in force, stored in license database 236, to determine if the rights being requested are available. In one embodiment, a request for license information is formatted as an HTML form and license manager 226 transforms the HTML formatted license information requests into SQL queries which are resolved by the relational database manager.

License database 236 stores license information including available license options and license options that are provided for each price tier. In a preferred embodiment, there are four licensing options basic, multi-user, product for release, and unlimited reproduction. It may be appreciated in the ensuing discussion that the user of the licensed media items may not be the customer that licensed the media items. Thus the term user refers to a user that is operating under the terms of the license. The basic license conveys to a user the right to incorporate the licensed media item into user generated content. The multi-user option enables multiple users to work with the license media item, i.e. use is not restricted to a single user. The product for release option enables a user to create and sell products that incorporate the media item. Finally, the unlimited reproduction option enables a user to incorporate the media item into a product or other user generated content and make unlimited reproductions of the product or user generated content. Any licensed media item comes with a basic license. Further, when a media item in the value tier is licensed the license includes all licensing options. When licensing a media item in the value or mid tier then license options in addition to the basic license may be purchased for an additional price.

License database 236 also stores any special information about individual media items. For example, a media item, such as a photo of a famous actor, may be prohibited from being used for an advertisement for an alcoholic beverage. Or, for example, a media item may have special pricing such that it doesn't fit into a price tier.

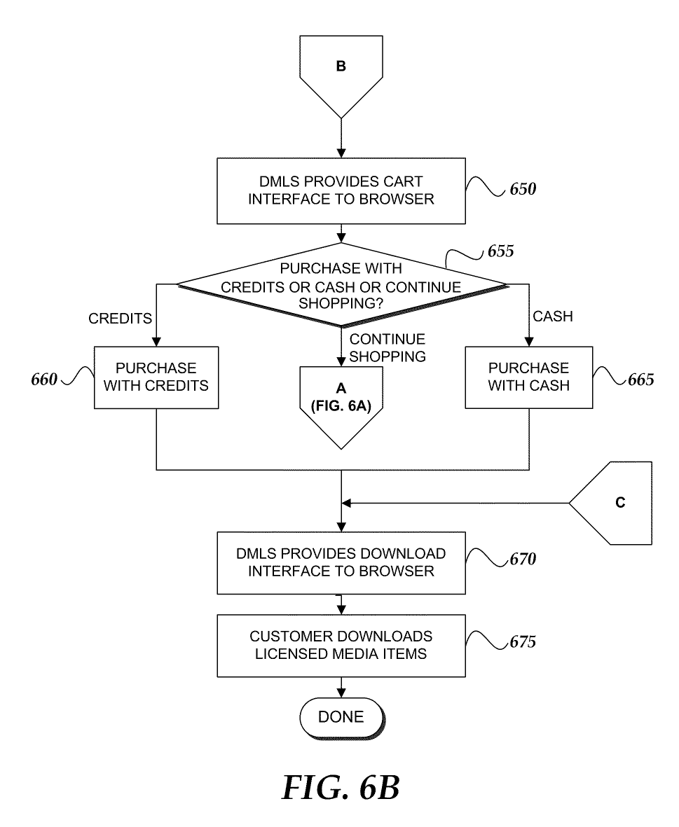

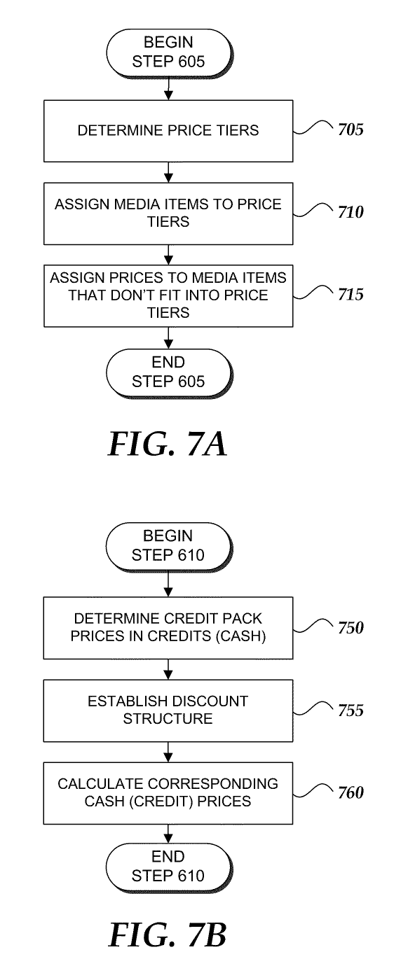

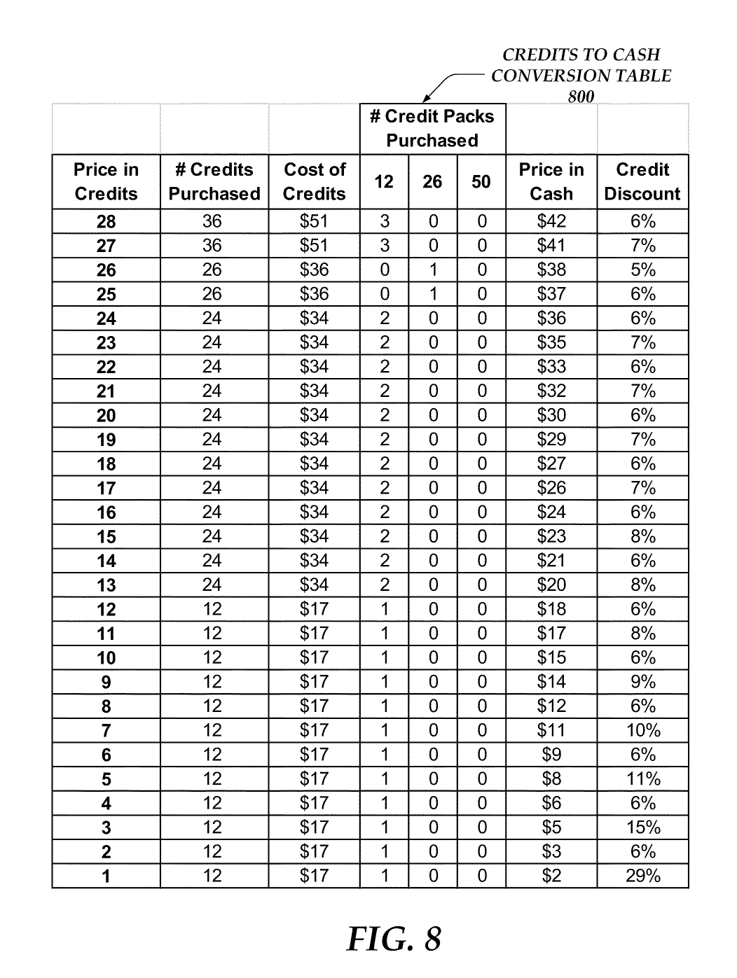

Pricer 228 responds to requests for prices. Pricer 228 obtains price information for one or more media items from purchase database 240. Pricer 228 can obtain a price in either or both of a cash or credits denomination. In one embodiment, price database 238 stores a credits to cash conversion table as well as a price in credits for each media item. In this embodiment, to provide a license price in cash for a media item, pricer 228 first obtains the price in credits from price database 238 and then looks up the associated cash value in the credits to cash conversion table. An exemplary credits to cash conversion table is provided in FIG. 8 and a method for determining a credits to cash conversion table is described with reference to FIG. 7B. In one embodiment, pricer 228 uses price information and pricing policies stored in price database 238 to compute or look-up the license prices on the fly. In one embodiment, pricing for a media item is based on the price tier to which it belongs and the size of the media item. As previously discussed, in a preferred embodiment, there are three price tiers: a lower priced “value” price tier; a moderately priced “mid” price tier; and a higher priced “premium” price tier. In this embodiment, each different size of a media item has a different price within the price tier. In this embodiment, pricing is established by defining price tiers, and prices for different sizes within each price tier, rather than being established individually for each media item.

In another embodiment, pricing is established by defining a set of versions for each media item. Each version has an associated price designation which is used to calculate or look-up the price of a version of the media item.

Cart manager 230 responds to request messages to update information about electronic carts that it manages for each customer. Cart manager 230 creates a cart for a customer when he/she first adds at least one item to the cart. Cart manager 230 maintains the cart in purchase database 240. Cart manager 230 maintains the contents of the cart between customer sessions. Thus, if a customer logs out or simply stops interacting for a period of time, and as a result his/her customer session terminates, cart manager 230 retains the customer's cart until he/she next logs in, thereby providing a persistent shopping cart. Thus, when a customer begins a new session, cart manager 230 updates the contents of the cart with information stored from the previous customer session. Information stored for a cart in purchase database 240 may include the name of the customer, a unique session identifier used to reference the session, the unique ID of each media item in the cart, the price quoted to license each media item, and the like.

Each time a customer performs an action that changes the state of the items in his/her cart, browser 204 sends a message requesting that cart manager 230 update the customer's cart stored in purchase database 240 accordingly. Actions a customer may perform on their cart include, inter alia, adding items, deleting items, pricing items, specifying or selecting a size for items and checking out.

Purchase database 240 stores information for each cart. Purchase database 240 may include the name of the customer, a unique session identifier used to reference the session, the unique ID for each media item in the cart, a size, and the price quoted for its use. In addition, purchase database 240 may store a designation of the license options purchased or applicable to a digital media item.

Reference is now made to FIG. 3, which is one embodiment of a search interface that enables a customer to search for digital images from an image library. Search interface 300 is provided by DMLS 220 to browser 204. A user of client device 202 uses search interface 300 to specify search criteria to be used to search media library 232.

Search interface 300 includes a search box 302, a search assistant 306, and a main window 320 that provides search controls and displays search results. Search interface 300 may include many more or less components than those shown in FIG. 3. However, the components shown are sufficient to disclose an illustrative embodiment for practicing the present invention.

A customer may specify search criteria by entering search terms into search box 302, by using inter alia a size-and-price filter 308, and by specifying attributes in an attributes checklist 312. Search assistant 306 is a window with several distinct areas, including size-and-price filter 308 and attributes checklist 312. Although search assistant 306 appears on the left side of search interface 300, the invention is not so limited. For example, search assistant 306 may also be displayed on the right side, or even at the bottom of search interface 300.

Size-and-price filter 308 provides a convenient method for a customer to search for digital media by size and price using either credits or cash price ranges as a filter. Using a series of radio buttons the customer selects a desired image size and a price range. In the example, the customer has specified that he/she wants to images of any size that cost up to 142 credits. In one embodiment, the price ranges correspond pricing tiers. Rather than indicating a price in size-and-price filter 308, a customer may select vector art, which is dimensionless.

Size-and-price filter 308 can display price ranges in either cash or credits. A customer can toggle between the cash and credits by selecting a currency type control 310, labeled “Filter using cash”. After selecting “Filter Using Cash” the price ranges are displayed in size-and-price filter 308, and currency type control 310 displays the corresponding label “Filter Using Credits”.

Attributes checklist 312 enables the customer to select which media item attributes to include in the search results. In example search interface 300 all attributes are checked, thus any media item that meets the search criteria as defined by the search terms in search box 302 and size-and-price filter 308 will be returned.

After modifying search criteria using any of the controls in search assistant 306 the customer uses an update search control 314 to execute the search using the new search criteria.

Search box 302 enables a customer to enter one or more search terms, also referred to as keywords. At any time, a customer may select a go control 304 to initiate a search. This causes browser 204 to send a search request message that includes the search criteria specified by the customer to application server 222. The requested search of media library 232 is performed by search manager 224 which, after performing the search, sends a response message that includes an image thumbnail 322, a price, and potentially other descriptive metadata for each media item in media library 232 that matches the specified search criteria. For each media item included in the responsive message, browser 204 displays image thumbnail 322, selected price information 324 and a set of controls 326 inside main window 320.

Image thumbnail 322 is computed by DMLS 220 from the actual media item stored in media library 232. For example, if the media item is an image then the thumbnail may be a reduced resolution version of the image. If the media item is a sound clip then a static image, perhaps showing a musical note, may be used. If the media item is a video clip then a key frame selected from the video clip may be used. It may be appreciated by one skilled in the art that there are many ways to represent media clips using image thumbnails. Further, in one embodiment, the size of the image thumbnails to be displayed may be selected by the customer.

Price information 324 includes a price range for licensing the media item, stated either in credits or currency. In example search interface 300, the customer has selected “all sizes” using the radio control, and up to 142 credits as the price range using size-and-price filter 308. Thus, all size media items that can be licensed for up to 142 credits are searched for, returned and displayed in main window 320. For each media item displayed in main window 320 price information 324 shows the range of license prices for licensing the media item, where the lowest price of the range corresponds to the smallest image size and the highest price corresponds to the largest image size. If the customer specifies a specific image size, e.g. small, medium, or large, using the radio control in size-and-price filter 308 then, for each returned media item, price information 324 displays the price to license the media item at the specified size. A customer can obtain prices in cash currency by selecting the “filter with cash value” control within size-and-price filter 308.

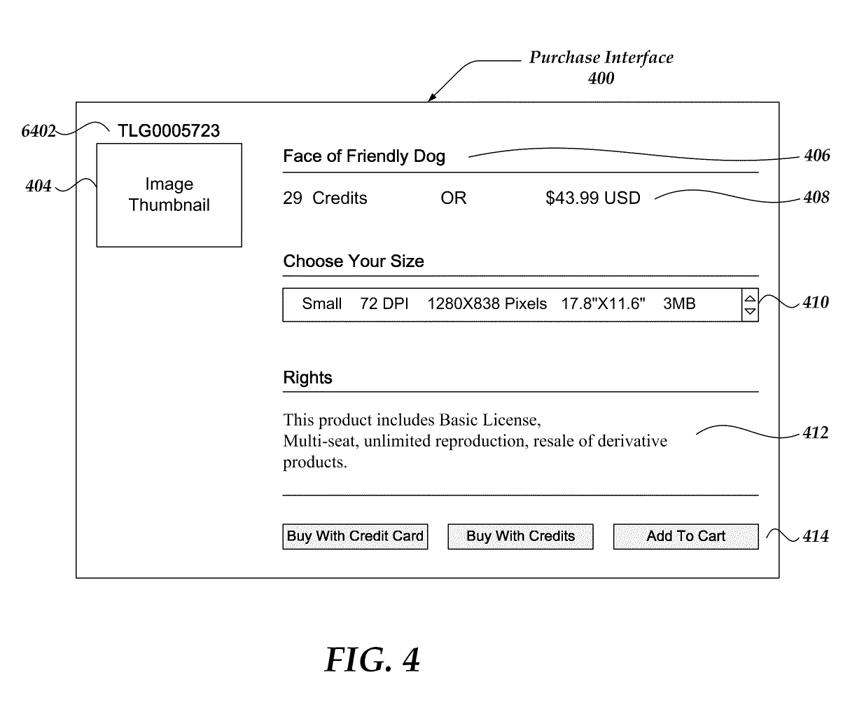

Controls 326 include: a “Buy” control, which, when selected, results in a purchase user interface, described in further detail with reference to FIG. 4, being displayed; a “Try” control, which, when selected, enables the customer to download a trial version of the media item that can be used, for example, for purposes of evaluation, or in a “mock-up” of an advertisement; and a “Save” control that saves a reference to the media item that the customer can later return to.

Main window 320 may display a progress animation while DMLS 220 performs the search, i.e. while the customer waits for the search results to be returned and displayed.

Main window 320 may extend beyond the visible portion of the window. The off-screen portions of main window 320 are accessed using a main window position control 316. Typically main window position control 316 is used to scroll the main window up and down. Typically main window 320 can accommodate a preset number of image thumbnails 322, for example 50 or 100. If the search results are greater than the preset number than additional pages are used to access the additional image thumbnails 322. The additional pages are accessed using a set of page controls 318. Page controls 318 include individual controls such as previous page and next page and enable the customer to select individual pages.

Now reference is made to FIG. 4, which is an illustration of one embodiment of a user interface for purchasing a license to a media item using cash or credits. Example purchase interface 400 displays a unique identifier 402 for the selected media item and an image thumbnail 404. Image thumbnail 404 may be the same as the corresponding image thumbnail 322 that appears in main window 320 of search interface 300. Or, it may be larger or smaller than image thumbnail 322.

Purchase interface 400 further displays a title 406 for the selected media item, as stored in the corresponding record in media library 232, a license price display 408 in both credits and cash denominations, a size selector 410 and a rights control 412. In example purchase interface 400 the setting for size selector 410 is small, or low resolution. If the customer, using search interface 300, previously filtered for small images, using size-and-price filter 308, then a small size is initially set when purchase interface 400 appears. The customer can select a different size using size selector 410 and the corresponding price appears in license price display 408. If the customer had not previously filtered on size, then a default size may be used, or alternatively the customer may be required to select a size using size selector 410.

In one embodiment, each media item is associated with a single price tier and specific license options or license rights are provided when licensing media items associated with a price tier. In a preferred embodiment, as previously discussed, there are three price tiers and four license options. However, the present invention can flexibly incorporate more or less price tiers and more or less license options. Rights control 412 lists the various license options included when licensing the selected media item. In the example, all four license options are included, namely basic license, multi-seat usage, unlimited reproduction and resale of derivative products with no additional royalty required. In one embodiment, selecting rights control 412 enables a customer to purchase additional license options for the media item.

A set of purchase controls 414 are available for use by the customer, including: a buy with a credit card control, a buy with credits control and an add to cart control. The buy with credit card control enables a customer to purchase the indicated license to the selected media item using a credit card. This is considered a cash purchase. In another embodiment, other cash purchases are supported including PayPal and other electronic payment methods. The buy with credits control enables a customer to purchase the indicated license using credits. If the customer has sufficient credits in his/her account then the account is debited the requisite number of credits. If there are not sufficient credits in the customer's account then he/she can purchase one or more credit packs, as necessary. Selecting the add to cart control adds the selected media item to the customer's electronic cart. The customer can later visit his/her electronic cart and check out, i.e. purchase, any media items in the cart. In one embodiment, if a customer is several credits short of being able to purchase the indicated license then he/she is provided with an option to “top up” his/her credits by purchasing just the required additional number of credits.

In another embodiment, a buy with cash and credits control is included in purchase controls 414. A buy with cash and credits control enables the customer to purchase a license partially using cash and partially using credits. In this embodiment, the customer designates how much of the purchase amount is to be made in cash and how much in credits prior to proceeding with the purchase.

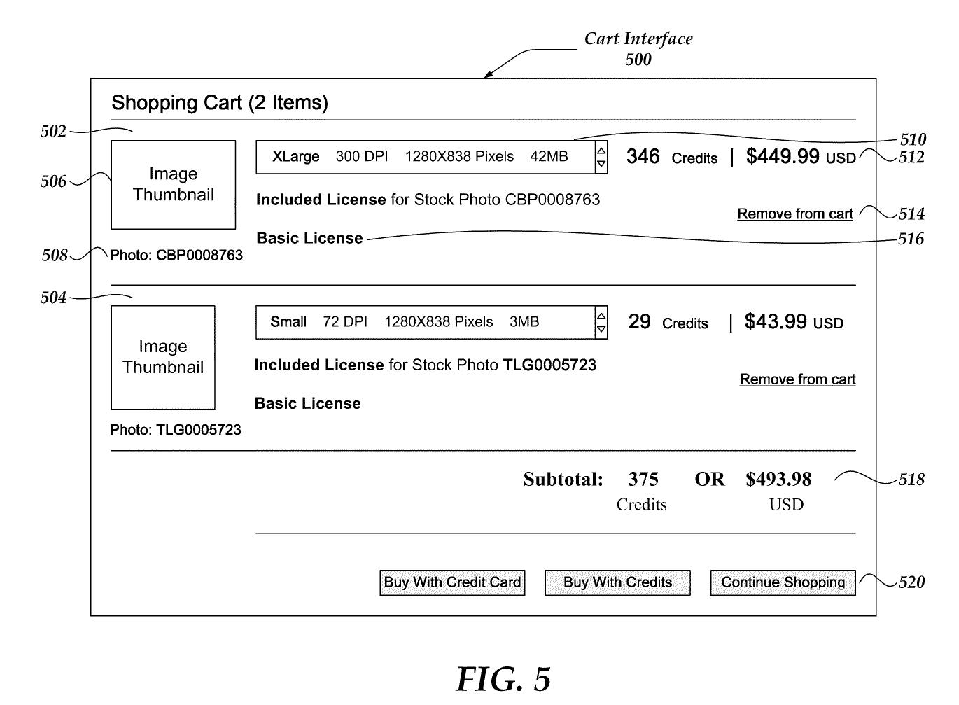

Now reference is made to FIG. 5, which is an illustration of one embodiment of a user interface for an electronic cart (“cart”) that enables a customer to license one or more media items using cash or credits. In one embodiment, every web page or user interface provided to a customer by DMLS 220 includes an option that, when selected, takes the customer directly to his/her cart. As previously discussed, a customer may add a media item to his/her cart using the “Add to Cart” control available from purchase controls 414.

Example cart interface 500 holds two media items, previously selected by a customer. The two media items are represented by cart items 502 and 504. Each cart item includes an image thumbnail 506, a unique identifier 508, a size selector 510, a price display 512, a remove from cart control 514 and a rights control 516. Size selector 510 enables the customer to select any available size for the media item. Price display 512 displays the price in both credits and cash to license the media item at the selected size. Remove from cart control 514 enables the customer to remove the media item from the cart. Rights control 516 lists the license options included when licensing the media item. In one embodiment, selecting rights control 516 enables a customer to purchase additional license options for the media item.

A subtotal display 518 shows the total price in both credits and cash for all items in the cart. Finally, purchase controls 520 provides: a buy with credit card control, a buy with credits control and a continue shopping control. The buy with credit card control enables a customer to purchase licenses to all items in the cart using a credit card. This is considered a cash purchase. In another embodiment, other cash purchases are supported including PayPal and other electronic payment methods. The buy with credits control enables a customer to purchase licenses to all items in the cart using credits. If the customer has sufficient credits in his/her account then the account is debited the requisite number of credits. If there are not sufficient credits in the customer's account then he/she can purchase one or more credit packs, as necessary. In one embodiment, if a customer is several credits short of being able to purchase the licenses in the cart then he/she is provided with an option to “top up” his/her credits by purchasing just the required additional number of credits. Selecting the continue shopping control returns the customer to search interface 500 where he/she can search and browse for additional media items. In this case, the customer can later visit his/her electronic cart and check out, i.e. purchase a license to, any media items in the cart.

In another embodiment, a buy with cash and credits control is made available as part of purchase controls 520. Such a control enables the customer to purchase licenses to media items in his/her cart license partially using cash and partially using credits. In this embodiment, the customer designates how much of the purchase amount is to be made in cash and how much in credits.

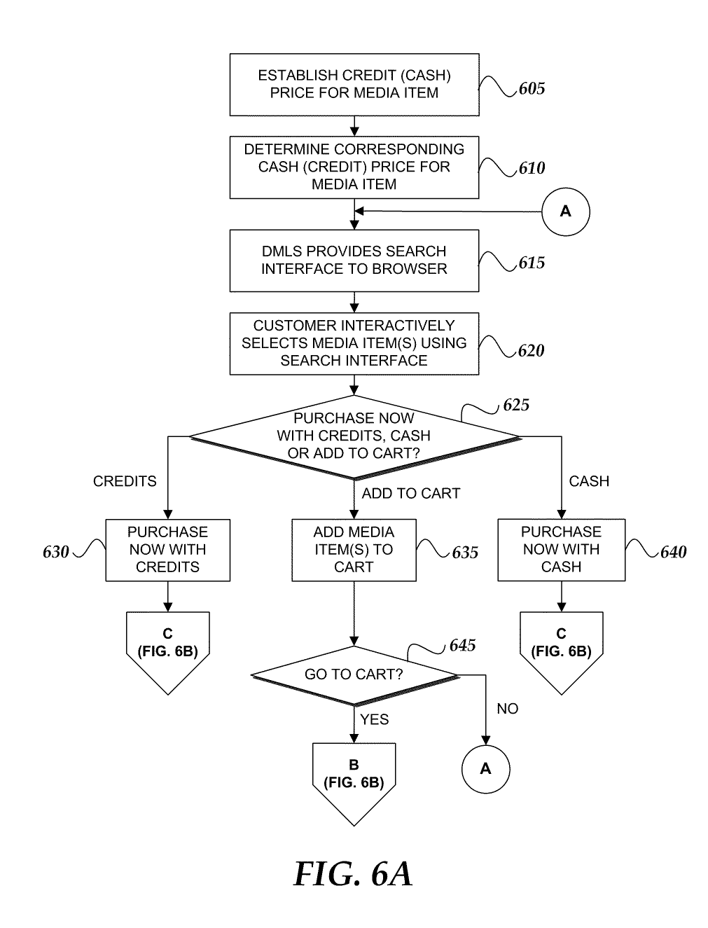

Now reference is made to FIGS. 6A and 6B, which are flow diagrams of a method that enables a customer to interactively search for, select and purchase licenses to one or more media items using cash or credits. The method enables a customer to view prices in cash or credits while interactively searching for, and while purchasing licenses to digital media items. Further, the method enables a customer to purchase with either cash or credits a license to a single item using purchase interface 400 or to purchase licenses to one or more items using cart interface 500. In this embodiment, credits are purchased as part of a credit pack.

At step 605 the price in credits for licensing a media item is established. Step 605 is described in further detail with reference to FIG. 7A. At step 610 the corresponding cash price for the media item is determined. Step 610 is described in further detail with reference to FIG. 7B. It may be appreciated that steps 605 and 610 may be performed in the opposite order. That is, first the cash price may be established and then the corresponding credit price may be determined. Further, steps 605 and 610 may be performed on a media item by media item basis, for example as the media items are provided to DMS 200 for licensing by contributors. Alternatively, steps 605 and 610 may be performed in a loop for all media items. In one embodiment, the result of steps 605 and 610 is the creation of a credit to cash conversion table, such as credit to cash conversion table 800, described with reference to FIG. 8. In another embodiment, step 605 may establish a cash price for a media item and step 610 may determine a corresponding credit price for the media item. In this embodiment steps 605 and 610 creates a cash to credit conversion table (rather than a credit to cash conversion table).

Typically, a customer navigates, using browser 204 to a web site provided by DMLS 220. Among other functions, the web site enables the customer to search and browse media items in media library 232. At step 615, in response to a request made by browser 204, DMLS 220 provides search interface 300 to browser 204. At step 620, using browser 404, the customer interactively searches for and selects media item(s) using search interface 300. The term “interactively searches” in this context means that a customer uses search interface 300 one or more times to select one or more media items. Additionally, “interactively searches” may include user interfaces in addition to search interface 300 that enable a customer to search for, browse and otherwise find and select digital media items.

At step 625, in response to the customer selecting a purchase control such as the buy control in controls 326, the customer is provided with a user interface such as purchase interface 400 that enables him/her to make a determination as to whether to purchase the selected media item(s) now with credits, to add the media item(s) to his/her cart, or to purchase the selected media item(s) now with cash. If the customer elects to purchase now with credits, then, at step 630, he/she is provided with a user interface that allows him/her to use his/her existing credits or to purchase one or more credit packs and apply them, together with any existing credits, to the purchase. In one embodiment, DMLS 220, using pricer 228, can recommend the combination of credit packs to purchase that minimize the cost of purchasing licenses to the selected media item(s). One method for determining the credit pack combination that yields the lowest purchase price for a given number of credits is described with reference to FIG. 8. When the customer has finished purchasing the license to the media item(s) using credits, processing resumes at off-page reference C (step 670 of FIG. 6B).

At step 635, if the customer elects to add the selected media item(s) to the cart, the customer is given the option to visit his/her cart or to return to search interface 300, in which case processing resumes at on-page reference A (step 615). If the customer elects to visit his/her cart then processing resumes at off-page reference B (step 650 of FIG. 6B).

If the customer elects to purchase now with cash, then, at step 640 the customer is provided with a user interface that allows him/her to use a credit card or other electronic purchasing method, such as PayPal, to purchase licenses to the selected media item(s). When the customer has finished purchasing the licenses, processing resumes at off-page reference C (step 670 in FIG. 6B).

Continuing on FIG. 6B, at step 650 DMLS 220 provides cart interface 500 to browser 204. When the customer is ready to proceed he/she makes a determination as to whether to purchase the items in the cart using credits or cash or whether to continue shopping, and not complete the purchase at this time.

If the customer elects to purchase using credits, then, at step 660, he/she is provided with a user interface that allows him/her to use his/her existing credits or to purchase one or more credit packs and apply them, together with any existing credits, to the purchase. In one embodiment, the DMLS 420, using pricer 228, can recommend the combination of credit packs to purchase that minimizes the cost of purchasing licenses to media item(s) in the cart. One method for determining the credit pack combination that yields the lowest purchase price for a given number of credits is described with reference to FIG. 8. When the customer has finished purchasing the license(s) to the media item(s) in the cart using credits processing resumes step 670.

If the customer elects to continue shopping then processing resumes at off-page reference A on FIG. 6A.

If the customer elects to purchase using cash, then, at step 665, the customer is provided with a user interface that allows him/her to use a credit card or other electronic purchasing method, such as PayPal, to purchase licenses to the media item(s) in the cart. When the customer has finished, processing resumes at step 670.

At step 670 DMLS 220 provides a user interface to browser 204 that enables the customer to download the media item(s) that were just licensed. Then, at step 675 the customer uses the supplied user interface to download the media item(s) client device 202.

Now reference is made to FIG. 7A, which illustrates a method for establishing a license price for a media item using credits purchased as part of a credit pack. FIG. 7A provides one exemplary method for performing step 605 of FIG. 6A. The method establishes a license price for a digital media item in credits. With little modification, the same method can be used to establish a cash value for a digital media item. Generally, this method is concerned with the pricing of digital media items licensed under a royalty free or microstock licensing model, although it may be applied to other licensing models as well.

At step 705 price tiers are optionally determined. This step may be helpful in establishing a uniform or rational basis for both media item prices and credit pack prices, but the step is not mandatory. Table 2, below, provides an example of two price tiers: a value tier and a mid tier. The two tiers given in Table 2 are especially suitable for the pricing of digital images since each of the two tiers includes a different price for each of six different image sizes, namely XXL, XL, L, M, S, and XS. Additionally, the different image sizes may be equated to levels of quality for digital music or digital video media items. In this example, the prices are established in credits, but prices could alternatively be established in cash, e.g. U.S. dollar prices.

TABLE 2
Example Price Tiers

| Tier | Size | Credits |
|---|---|---|
| Value | XXL | 20 |
| | XL | 15 |
| | L | 10 |
| | M | 6 |
| | S | 3 |
| | XS | 1 |
| Mid | XXL | 60 |
| | XL | 50 |
| | L | 40 |
| | M | 30 |
| | S | 20 |
| | XS | 10 |

At step 710 the media item is assigned to a price tier. Thus, in a three tier price model a media item may be assigned to either a value, mid or premium price tier. The assignment may be made based on perceived quality of each media item, or a group of media items may be assigned in a batch to a price tier.

At step 715 if the media item doesn't fit into the three tier pricing model (premium, mid, and value) it is assigned special pricing. An example of a media item that doesn't fit with the three tier pricing system is a media item for which pricing is specifically established in an agreement between a content provider and the operator of DMS 200.

Now reference is made to FIG. 7B, which illustrates a method for determining a corresponding cash price for licensing a media item when the price was initially established in credits. FIG. 7B provides one exemplary method for performing step 610 of FIG. 6A. The method determines a license price for a digital media item in cash. With little modification, the same method can be used to determine a license price in credits for a digital media item, in the case where the price was previously established in cash. Generally, this method is concerned with the pricing of digital media items licensed under a royalty free or microstock licensing model.

At step 750 credit pack prices are determined. Typically credits are sold at a discount relative to cash. That is, the price for a media item is cheaper when paying in credits as opposed to cash. The rationale is that credits are sold in a pack and often a customer must purchase more credits than are required for their immediate purchase. Thus to realize the full value of his/her purchase of a credit pack a customer may have to return to DMS 200. Thus, the customer is given a “loyalty” discount when paying with credits since he/she makes an implicit agreement to return and use DMS 200 again in the future. This is typically referred to as a customer loyalty program.

Various strategies can be employed in establishing pricing for a credit pack. For example, if the most commonly purchased images are medium size value tier (6 credits) and large value tier (10 credits) then a goal might be to have a 12 credit level in a credit pack credit pack that enables a customer to purchase 1 large value tier image or two medium size value tier images. Competitive and other market factors may also be taken into account in establishing credit pack pricing. One credit pack pricing scheme is given in Table 3 below.

TABLE 3
Example Credit Pack Pricing

| # of Credits | Price in USD |
|---|---|
| 12 | 17 |
| 26 | 36 |
| 50 | 67 |
| 120 | 155 |
| 300 | 360 |
| 600 | 640 |
| 1000 | 995 |
| 1500 | 1435 |
| 2000 | 1760 |

In Table 3 the smallest number of credits a customer can purchase in a single block is 12 and the largest number of credits a customer can purchase in a single block is 2000. However, a customer can purchase multiple packs and combine the credits to make a purchase. Thus, referring to Table 2, if a customer desires to purchase licenses to two large size value tier images (10 credits apiece) and an extra large value tier image (15 credits) requiring a total of 35 credits then the cheapest purchase of credits would be a block 26 credits (costing $36) and a block of 12 credits (costing $17). In this example, the customer pays a total of $36+$17=$53 for 38 credits. After paying for a license to the three images the customer would have 3 credits remaining in his/her account, i.e. 38 credits purchased in two credit packs—35 credits used to purchase licenses to the three images.

As previously discussed, it is common, although not necessary that the use of credits be encouraged through discounted pricing. Thus, at step 755 a discount structure is determined. In one embodiment, depicted in FIG. 8, a target is for credit prices to be 6% less than their corresponding cash prices.

At step 760, for each credit value a corresponding cash price is calculated, taking into account the discount structure, if any, determined in the previous step and the credit pack pricing established in step 750. FIG. 8 provides one example of a credit to cash conversion table in which a cash price is calculated for each credit value. One method for calculating a corresponding cash value is described with reference to FIG. 8.

Now reference is made to FIG. 8, which provides an exemplary credits to cash conversion table used in converting credit prices to cash prices for licenses to media items. The column titled “Price in Credits” lists sequential credit values in descending order, from 28 to 1. Using the credit pack pricing given in Table 3 and a target discount rate of 6% in purchasing with credits rather than cash, pricer 428 computes all remaining columns in the table. The computations employed scale to any credit value, i.e. to any value greater than 28. Credit to cash conversion table 800 enables pricer 228 to provide a corresponding price in cash for any price in credits. It also enables pricer 228 to recommend the combination of credit packs for a customer to purchase to obtain a number of credits for the lowest price. Table 4, below, describes the values in each column of credit to cash conversion table 800:

TABLE 4
Credit to cash conversion table Calculations

| Column(s) | Description & Calculation |
|---|---|
| Credits Purchased | The total number of credits purchased when |
| | the combination of license packs |
| | recommended in the columns “Credit Packs |
| | Purchased” are purchased. |
| Cost of Credits | The price for purchasing the combination of |
| | license packs recommended in the columns |
| | “Credit Packs Purchased.” Computed as the |
| | sum of the products of the number of each |
| | size license pack purchased times the cost of |
| | the license pack. |
| Credit Packs | The combination of credit packs which when |
| Purchased | purchased yields the lowest price to purchase |
| | the desired number of credits (given in the |
| | column “Price in Credits”). The algorithm for |
| | determining the value of each credit pack to |
| | purchase is given below under Algorithm A. |
| Price in Cash | The corresponding price in cash for a given |
| | number of credits. The calculation of this |
| | value is given below, see Equation A. |
| Credit Discount | The actual discount provided when paying with |
| | credits relative to the cash purchase price. |

Algorithm A: An algorithm, written in visual basic for a Microsoft Excel spreadsheet is given below that determines the optimal combination of credit packs for the customer to purchase. It consists of two subroutines: SolverMultipleRows( ) which sequentially processes each row in the table, and SolverCredit( ) which calculates the various values for each row. Subroutine SolverMultipleRows( ) is given below:

Sub SolverMultipleRows( )
Dim i As Integer
Dim j As Integer
For i = 14 To 813

Cells(i, 4).Select
Application.CutCopyMode = False
Selection.Copy
Range(“D5”).Select
ActiveSheet.Paste
Application.Run “‘Cash & credits - 13Feb10.xls’!SolverCredit”
Range(“G5:O5”).Select
Selection.Copy
Cells(i, 7).Select
ActiveSheet.Paste

Next i
End Sub

In the forgoing subroutine, SolverMultipleRows( ) for each of the 800 rows in the credit to cash conversion table, numbered 14 to 813, first the credit value to be computed, Cells(i, 4), is copied to a specific cell location (“D5”) and then, subroutine SolverCredit( ) is executed. Subroutine SolverCredit( ) given below, computes the minimum number of credit packs of each size to be purchased that will yield the lowest price and returns these values in cells G5:05. SolverCredit( ) uses the common Solver add-in for Microsoft Excel, from FrontLine systems. SolverMultipleRows( ) then pastes these values into the table in the proper row.

Sub SolverCredit( )

Range(“F5”).Select
SolverReset
SolverOk SetCell:=“$F$5”, MaxMinVal:=2, ValueOf:=“0”,

ByChange:=“$G$5:$O$5”

SolverAdd CellRef:=“$E$5”, Relation:=3, FormulaText:=“$D$5”
SolverOk SetCell:=“$F$5”, MaxMinVal:=2, ValueOf:=“0”,

ByChange:=“$G$5:$O$5”

SolverAdd CellRef:=“$G$5:$O$5”, Relation:=3,

FormulaText:=“0”

SolverOk SetCell:=“$F$5”, MaxMinVal:=2, ValueOf:=“0”,

ByChange:=“$G$5:$O$5”

SolverAdd CellRef:=“$G$5:$O$5”, Relation:=4,

FormulaText:=“integer”

SolverOk SetCell:=“$F$5”, MaxMinVal:=2, ValueOf:=“0”,

ByChange:=“$G$5:$O$5”

SolverSolve (True)

End Sub

In the above routine, SolverCredit( ) determines the minimum cost in credits for purchasing a specified number of credits where the minimum cost is determined by varying the number of credit packs purchased and using the price per credit in purchasing a credit pack. SolverCredit( ) determines the minimum value of SUMPRODUCT($G$3:$O$3,G5:05), the sum of the products across the two cell ranges G3:03 and G5:05 in Table 4, below, for a particular number of credits to be purchased. The values in ranges G3:03 and G:04 in Table 4, below, correspond to the credit pack pricing in Table 3.

TABLE 4

| | E | F | G | H | I | J | K | L | M | N | O |
|---|---|---|---|---|---|---|---|---|---|---|---|
| 3 | | | $17 | $36 | $67 | $155 | $360 | $640 | $995 | $1,435 | $1,760 |
| 4 | | | 12 | 26 | 50 | 120 | 300 | 600 | 1000 | 1500 | 2000 |
| 5 | 24 | $34 | 2 | 0 | 0 | 0 | 0 | 0 | 0 | 0 | 0 |
| 6 | | | $1.42 | $1.38 | $1.34 | $1.29 | $1.20 | $1.07 | $1.00 | $0.96 | $0.88 |

In the example given in Table 4, above, SolverCredit( ) computes the number of credits purchased, given in cell E5 as 24, the cost of purchasing the credits, given in cell F5 as $34, and the optimal combination of credit packs to purchase, give in cells G5:05, for the case where the customer wants to purchase 18 credits. In the example, the customer must purchase two 12 credit license packs for $34 and will obtain 24 credits. Thus, after the 18 credit purchase the customer will have 6 credits remaining.

Equation A: The equation for the corresponding price in cash for a given number of credits is given as:

Price in cash=ROUND(Price in Credits*(Cost of Credits/Credits Purchased)/(1−Discount))

where Round is a function that rounds the result to the nearest whole dollar amount, and Discount is the target discount rate of 6% in this example.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems that perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed is:

1. A method for licensing digital media items, comprising:
providing a search interface for a web browser, which enables a customer to interactively select one or more media items from a plurality of media items available for licensing;
establishing prices in credits for licenses to the plurality of media items;
determining cash prices corresponding to the prices in credits for the licenses to the plurality of media items;
enabling a customer to purchase one or more credit packs, each credit pack including a specified number of credits for a specified price; and
enabling the customer to pay for the licenses to the one or more selected media items with cash, or with credits from the one or more credit packs purchased by the customer.

2. The method of claim 1 wherein the cash price corresponding to a price in credits is based in part on a designated discount for purchasing with credits rather than with cash.

3. The method of claim 1 wherein the cash price corresponding to a specified price in credits is based in part on the lowest price for purchasing credit packs that cumulatively contain at least the specified price in credits.

4. The method of claim 1 wherein said enabling the customer to pay comprises:
enabling the customer to pay with unused credits from a previously purchased credit pack; and
enabling the customer to purchase one or more credit packs and to pay with credits from the one or more purchased credit packs.

5. The method of claim 1 wherein said enabling the customer to pay comprises:
enabling the customer to pay with unused credits from a previously purchased credit pack; and
if there are insufficient unused credits from a previously purchased credit pack to pay for the licenses to the one or more selected media items, then enabling the customer to purchase the exact number of credits which when combined with said unused credits are sufficient to pay for the licenses.

6. The method of claim 1 wherein said enabling a customer to pay includes enabling the customer to pay with a combination of cash and credits.

7. The method of claim 1 wherein the search interface enables the customer to filter media items for selection based on a price range in cash or credits.

8. The method of claim 1 wherein the search interface enables the customer to filter media items for selection based on a size and on a price range in cash or credits.

9. The method of claim 1 further comprising enabling the customer to add said interactively selected one or more media items to an electronic cart, and wherein said enabling the customer to pay comprises:
providing an electronic cart interface to the customer; and
enabling the customer to pay for the licenses using the electronic cart interface.

10. A system for licensing digital media items, comprising:
a pricer for
establishing prices in credits for licenses to a plurality of media items available for licensing; and
determining cash prices corresponding to the prices in credits for the licenses to the plurality of media items; and
an application server for
providing a search interface for a web browser, which enables a customer to interactively select one or more media items from the plurality of media items available for licensing; and
providing a purchase interface for a web browser, which
enables a customer to purchase one or more credit packs, each credit pack including a specified number of credits for a specified price; and
enables the customer to pay for the licenses to the one or more selected media items with cash, or with credits from the one or more credit packs.

11. The system of claim 10 wherein the cash price corresponding to a price in credits is based in part on a designated discount for purchasing with credits rather than with cash.

12. The method of claim 10 wherein the cash price corresponding to a specified price in credits is based in part on the lowest price for purchasing credit packs that cumulatively contain at least the specified price in credits.

13. The system of claim 10 wherein said enabling the customer to pay comprises:
enabling the customer to pay with unused credits from a previously purchased credit pack; and
enabling the customer to purchase one or more credit packs and to pay with credits from the one or more purchased credit packs.

14. The system of claim 10 wherein said enabling the customer to pay comprises:
enabling the customer to pay with unused credits from a previously purchased credit pack; and
if there are insufficient unused credits from a previously purchased credit pack to pay for the licenses to the one or more selected media items, then enabling the customer to purchase the exact number of credits which when combined with said unused credits are sufficient to pay for the licenses.

15. The system of claim 10 wherein said enabling a customer to pay includes enabling the customer to pay with a combination of cash and credits.

16. The system of claim 10 wherein the search interface enables the customer to filter media items for selection based on a price range in cash or credits.

17. The method of claim 10 wherein the search interface enables the customer to filter media items for selection based on a size and on a price range in cash or credits.

18. The method of claim 10 further comprising enabling the customer to add said interactively selected one or more media items to an electronic cart, and wherein said enabling the customer to pay comprises:
providing an electronic cart interface to the customer; and
enabling the customer to pay for the licenses using the electronic cart interface.

19. A nontransitory computer readable storage medium storing program code for causing a computing device:
to provide a search interface for a web browser, which enables a customer to interactively select one or more media items from a plurality of media items available for licensing;
to establish prices in credits for licenses to the plurality of media items;
to determine cash prices corresponding to the prices in credits for the licenses to the plurality of media items;
to enable a customer to purchase one or more credit packs, each credit pack including a specified number of credits for a specified price; and
to enable the customer to pay for the licenses to the one or more selected media items with cash, or with credits from the one or more credit packs purchased by the customer.
